(19) United States
(12) Patent Application Publication
(10) Pub. No.: US 2026/0208349 A1
(43) Pub. Date: Jul. 23, 2026

(54) TOROIDAL ENVELOPING WORM AND HELICAL GEAR TRANSMISSION MECHANISM FOR ROBOT FINGER JOINT, AND ROBOT

(71) Applicant: Talls Intelligent Technology (Shenzhen) Co., Ltd., Shenzhen (CN)

(72) Inventors: Yulong TAO, Shenzhen (CN); Lei TAO, Shenzhen (CN); Yangyang LI, Shenzhen (CN); Zekai TAO, Shenzhen (CN)

(73) Assignee: Talls Intelligent Technology (Shenzhen) Co., Ltd., Shenzhen (CN)

(21) Appl. No.: 19/430,770

(22) Filed: Dec. 23, 2025

(30) Foreign Application Priority Data
Jan. 20, 2025 (CN) 202510083441.0

(51) Int. Cl. B25J 9/10; B25J 15/08; B25J 17/00

(52) U.S. Cl. CPC B25J 9/102; B25J 9/108; B25J 15/08; B25J 17/00

(57) ABSTRACT

A toroidal enveloping worm and helical gear transmission mechanism for the robot finger joint includes a housing, a toroidal enveloping worm, a helical gear shaft and a drive motor. The housing is provided with a first accommodating cavity and a second accommodating cavity communicated with first accommodating cavity, and each of the opposite side walls of the second accommodating cavity is provided with a through hole. The toroidal enveloping worm is provided in the first accommodating cavity. The helical gear shaft is provided in the second accommodating cavity and meshes with the toroidal enveloping worm, and both ends of the helical gear shaft respectively pass through the two through holes. The output shaft of the drive motor is connected to the toroidal enveloping worm, and the drive motor drives the toroidal enveloping worm to rotate.

### CROSS-REFERENCE TO RELATED APPLICATIONS

This application claims priority to Chinese Patent Application No. 202510083441.0, filed on January 20, 2025, the entire contents of which are incorporated herein by reference.

### TECHNICAL FIELD

The present application relates to the technical field of robots, and in particular to a toroidal enveloping worm and helical gear transmission mechanism for a robot finger joint, and a robot.

### BACKGROUND

In the field of humanoid robots, the dexterous hand is a key component, and its performance directly affects the overall functionality of the robot. In related art, the finger joints of the dexterous hand are driven by either a rope-driven mechanism or a planetary roller screw drive mechanism. However, rope-driven mechanisms suffer from low precision and short lifespan, making them unsuitable for practical applications. Planetary roller screw drive mechanisms are noisy, bulky, and difficult to integrate.

### SUMMARY

The main purpose of the present application is to provide a toroidal enveloping worm and helical gear transmission mechanism for a robot finger joint, and a robot, aiming to provide a transmission mechanism that is small in size and high in precision.

In order to achieve the above purpose, the present application provides a toroidal enveloping worm and helical gear transmission mechanism for a robot finger joint, including: a housing, a toroidal enveloping worm, a helical gear shaft and a drive motor;

the housing is provided with a first accommodating cavity and a second accommodating cavity communicated with the first accommodating cavity, and each of the opposite side walls of the second accommodating cavity is provided with a through hole;

the toroidal enveloping worm is provided in the first accommodating cavity;

the helical gear shaft is provided in the second accommodating cavity, the helical gear shaft meshes with the toroidal enveloping worm, and both ends of the helical gear shaft respectively pass through the two through holes;

an output shaft of the drive motor is connected to the toroidal enveloping worm, and the drive motor drives the toroidal enveloping worm to rotate; and

an axis of the toroidal enveloping worm is perpendicular to an axis of the helical gear shaft.

In an embodiment, the toroidal enveloping worm includes a rod body and a plurality of teeth provided at the rod body, and the plurality of teeth form a transmission section; and

the helical gear shaft meshes with the transmission section, and an outer diameter of the teeth gradually increases from a middle portion of the transmission section to both ends of the transmission section.

In an embodiment, a transmission ratio of the toroidal enveloping worm and helical gear transmission mechanism for the robot finger joint is 10:1 to 30:1.

In an embodiment, the toroidal enveloping worm and helical gear transmission mechanism for the robot finger joint further includes: an eccentric sleeve;

the eccentric sleeve is rotatably provided in the first accommodating cavity, a middle portion of the eccentric sleeve is provided with a through hole, and eccentric holes are provided at both ends of the eccentric sleeve; and

the toroidal enveloping worm is provided in the eccentric sleeve, two ends of the toroidal enveloping worm are respectively rotatably provided in each of the eccentric holes, and a portion of the helical gear shaft passes through the through hole and meshes with the toroidal enveloping worm.

In an embodiment, an annular groove is formed on an inner wall of the first accommodating cavity; and

an annular protrusion is formed on an outer wall of the eccentric sleeve, and the annular protrusion is engaged with the annular groove.

In an embodiment, a distance between an axis of the toroidal enveloping worm and an axis of the helical gear shaft is 3 mm to 8 mm.

In an embodiment, a module of the toroidal enveloping worm and a module of the helical gear shaft are both m, where 0.15≤m≤0.5.

In an embodiment, the toroidal enveloping worm and helical gear transmission mechanism for the robot finger joint further includes: two first bearings, the two first bearings are provided in the first accommodating cavity, and the two first bearings are respectively sleeved on both ends of the toroidal enveloping worm.

In an embodiment, the toroidal enveloping worm and helical gear transmission mechanism for the robot finger joint further includes: two second bearings, the two second bearings are provided in the second accommodating cavity, and the two second bearings are respectively sleeved on both ends of the helical gear shaft.

In an embodiment, the toroidal enveloping worm and helical gear transmission mechanism for the robot finger joint further includes: two sealing rings, the two sealing rings are respectively sleeved on both ends of the helical gear shaft, and each of the sealing rings is hermetically attached to a hole wall of one of the through holes.

The present application also provides a robot, and the robot includes the toroidal enveloping worm and helical gear transmission mechanism for the robot finger joint described above.

In the technical solution of the present application, two transmission rods are configured to be connected to the force arm of the robot finger joint. The drive motor drives the toroidal enveloping worm to rotate, and the toroidal enveloping worm drives the helical gear shaft to rotate. The transmission rods rotate together with the helical gear shaft. The transmission rods drive the force arm to move and realize the bending movement of the finger. Moreover, by the forward and reverse rotation of the drive motor, the bending and extension of the finger can be controlled.

High-precision transmission control can be achieved through the meshing of the toroidal enveloping worm and the helical gear shaft, with low noise and self-locking capability. The first accommodating cavity and the second accommodating cavity provided in the housing enable the toroidal enveloping worm and the helical gear shaft to be integrated within the housing, resulting in a smaller size, making it suitable for space-constrained robot finger joints.

### BRIEF DESCRIPTION OF THE DRAWINGS

In order to more clearly illustrate the embodiments of the present application, the following briefly describes the drawings required for use in the embodiments. Obviously, the drawings described below represent only some embodiments of the present application. Persons skilled in the art can, without inventive effort, derive other drawings based on the structures shown in these drawings.

FIG. 1 is a schematic structural view of a toroidal enveloping worm and helical gear transmission mechanism for a robot finger joint according to an embodiment of the present application.

FIG. 2 is a schematic structural view of the toroidal enveloping worm and helical gear transmission mechanism for the robot finger joint according to another embodiment of the present application.

FIG. 3 is an exploded structural view of the toroidal enveloping worm and helical gear transmission mechanism for the robot finger joint according to an embodiment of the present application.

FIG. 4 is a cross-sectional view of the toroidal enveloping worm and helical gear transmission mechanism for the robot finger joint according to an embodiment of the present application.

FIG. 5 is a cross-sectional view of the toroidal enveloping worm and helical gear transmission mechanism for the robot finger joint according to another embodiment of the present application.

FIG. 6 is a schematic structural view of a toroidal enveloping worm according to an embodiment of the present application.

The realization of the purpose, functional characteristics, and advantages of the present application will be further explained in conjunction with embodiments and with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

It should be noted that if the embodiments of the present application involve directional indications (such as up, down, left, right, front, back, etc.), these directional indications are only used to explain the relative positional relationship and movement of the components in a specific posture. If the specific posture changes, the directional indications will also change accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicating the number of technical features indicated. Thus, a feature delimited with “first”, “second” may expressly or implicitly include at least one of these features. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of the present application.

The present application proposes a toroidal enveloping worm and helical gear transmission mechanism for the robot finger joint 100.

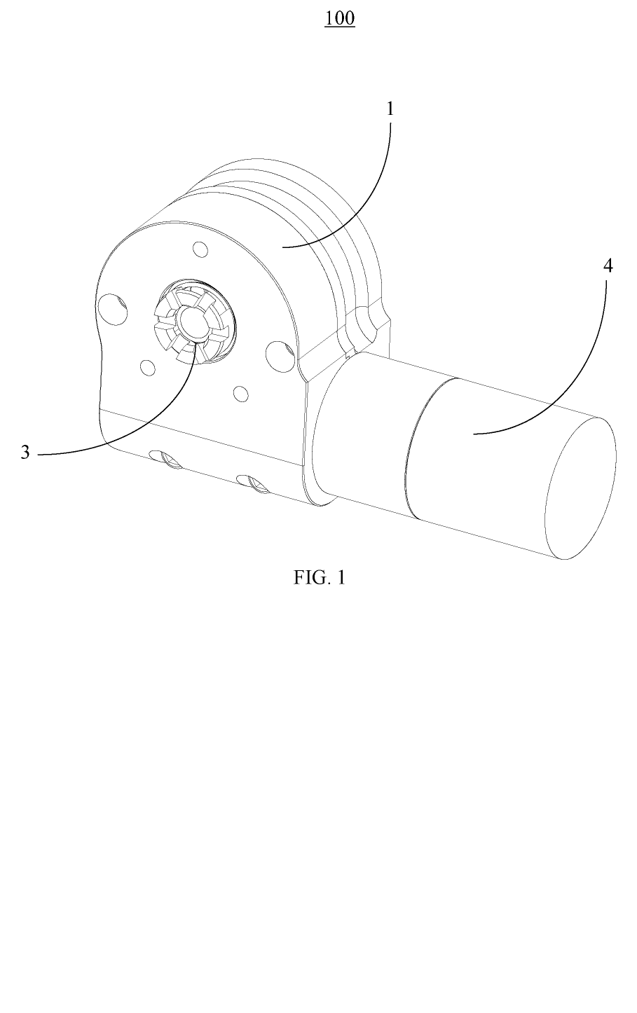

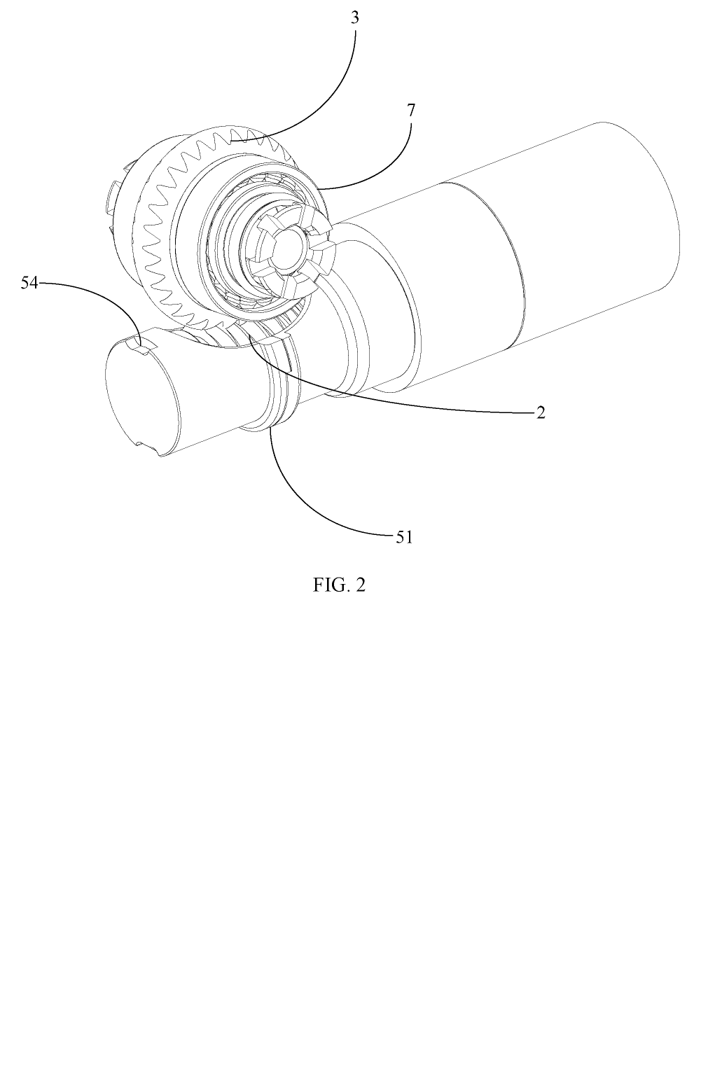

Referring to FIG. 1 and FIG. 2, in an embodiment of the present application, the toroidal enveloping worm and helical gear transmission mechanism for the robot finger joint 100 includes a housing 1, a toroidal enveloping worm 2, a helical gear shaft 3 and a drive motor 4. The housing 1 is provided with a first accommodating cavity and a second accommodating cavity communicated with the first accommodating cavity, and each of opposite side walls of the second accommodating cavity is provided with a through hole. The toroidal enveloping worm 2 is provided in the first accommodating cavity. The helical gear shaft 3 is provided in the second accommodating cavity and meshes with the toroidal enveloping worm 2, and both ends of the helical gear shaft 3 respectively pass through the two through holes. The output shaft of the drive motor 4 is connected to the toroidal enveloping worm 2, and the drive motor 4 drives the toroidal enveloping worm 2 to rotate. The axis of the toroidal enveloping worm 2 is perpendicular to the axis of the helical gear shaft 3.

The dexterous hand of a humanoid robot mimics the design of a human hand, typically having five fingers, each with three joints, and each joint having one degree of freedom. The toroidal enveloping worm and helical gear transmission mechanism for the robot finger joint 100 of this embodiment is applied to the finger joints of the robot. The two ends of the helical gear shaft 3 are configured to be connected to the force arms of the robot finger joint. The drive motor 4 drives the toroidal enveloping worm 2 to rotate, and the toroidal enveloping worm 2 drives the helical gear shaft 3 to rotate. The two ends of the helical gear shaft 3 drive the force arms to achieve the bending movement of the fingers. By forward and reverse rotation of the drive motor 4, the bending and extension of the fingers can be controlled.

The housing 1 includes two side plates, and the two side plates enclose to form a first accommodating cavity and a second accommodating cavity. The two side plates are connected by screws to facilitate the assembly of the transmission mechanism. Specifically, the toroidal enveloping worm 2, the helical gear shaft 3 and the drive motor 4 can be assembled onto one of the side plates first, and then the two side plates can be connected to complete the assembly.

The drive motor 4 can be provided inside the housing 1 or outside the housing 1. Considering the size of the housing 1, in this embodiment, the drive motor 4 is provided outside the housing 1. By providing a circular hole on the housing 1 that communicates with the first accommodating cavity, the output shaft of the drive motor 4 can extend into the first accommodating cavity to drive the toroidal enveloping worm 2 to rotate. In this way, the housing 1 only needs to accommodate the toroidal enveloping worm 2 and the helical gear shaft 3, which helps to reduce the volume of the housing 1 and facilitates its use in a small space.

The axis of the toroidal enveloping worm 2 is perpendicular to the axis of the helical gear shaft 3. As can be seen from the above, the axis of the toroidal enveloping worm 2 will be perpendicular to the robot finger. That is, the drive motor 4 can be perpendicular to the robot finger. Compared with the parallel provided with the robot finger, the perpendicular provided can better mount the drive motor 4 at the robot finger joint and reduce the space required for the installation of the toroidal enveloping worm and helical gear transmission mechanism for the robot finger joint 100.

In the technical solution of the present application, high-precision transmission control can be achieved through the meshing transmission of the toroidal enveloping worm 2 and the helical gear shaft 3, with low noise and self-locking capability. The first accommodating cavity and the second accommodating cavity provided in the housing 1 allow the toroidal enveloping worm 2 and the helical gear shaft 3 to be integrated within the housing 1, making it suitable for use in space-constrained areas such as robot finger joints. The toroidal enveloping worm 2 and the helical gear shaft 3 are made of high-strength steel, possessing high tensile strength, good yield strength, and good fatigue resistance.

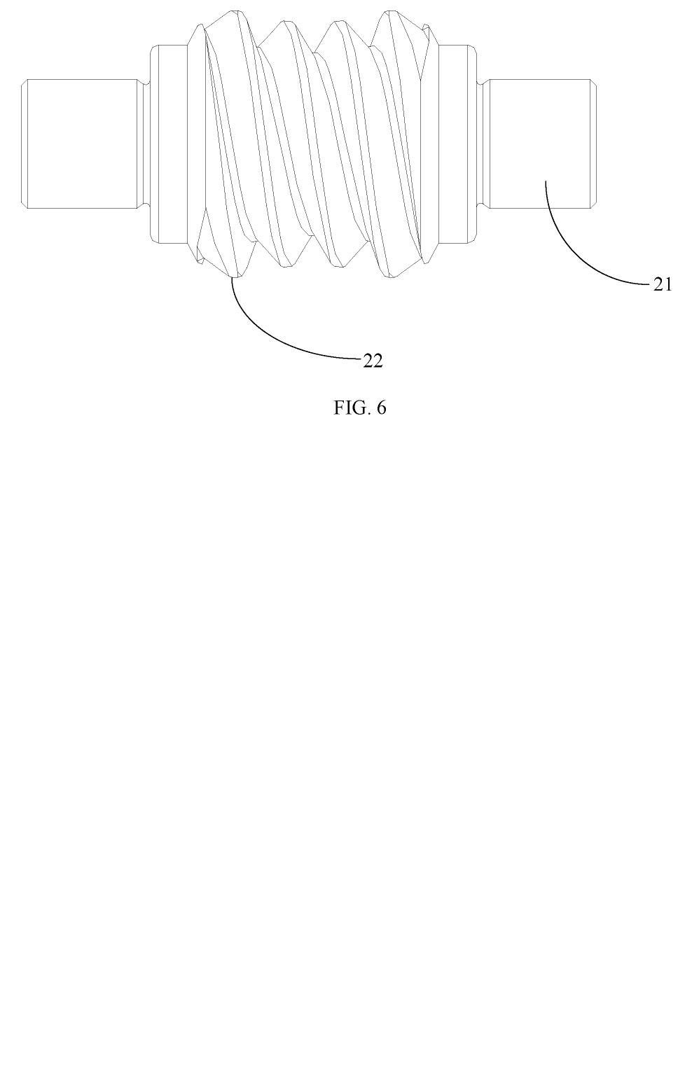

In an embodiment of the present application, referring to FIG. 6, the toroidal enveloping worm 2 includes a rod body 21 and a plurality of teeth 22 provided at the rod body 21. The plurality of teeth 22 form a transmission section, and the helical gear shaft 3 meshes with the transmission section. From the middle portion to both ends of the transmission section, the outer diameter of the teeth 22 gradually increases. That is, the height of the teeth 22 at both ends of the transmission section is greater than the height of the teeth 22 at the middle portion of the transmission section. The plurality of teeth 22 are distributed in a similar arc shape. In this way, when the helical gear shaft 3 meshes with the toroidal enveloping worm 2, multi-tooth meshing can be achieved, thereby generating a larger output torque, thus effectively transmitting the power of the drive motor 4 to the robot finger and improving the robot’s performance. In addition, by providing the dimension of the toroidal enveloping worm 2 and the dimension of the helical gear shaft 3, the toroidal enveloping worm and helical gear transmission mechanism for the robot finger joint 100 can have a self-locking capability, eliminating the need to design an additional locking mechanism.

In an embodiment of the present application, the transmission ratio of the toroidal enveloping worm and helical gear transmission mechanism for the robot finger joint 100 is 10:1 to 30:1. That is, the toroidal enveloping worm and helical gear transmission mechanism for the robot finger joint 100 has a high reduction ratio, which can provide precise speed control, thereby ensuring the accuracy of the robot finger movement. In addition, it also ensures the flexibility and adaptability of the toroidal enveloping worm and helical gear transmission mechanism for the robot finger joint 100 in different application scenarios.

In order to accommodate robot fingers of different sizes, in an embodiment of the present application, the distance between the axis of the toroidal enveloping worm 2 and the axis of the helical gear shaft 3 is 3 mm to 8 mm. That is, the center distance between the toroidal enveloping worm 2 and the helical gear shaft 3 is 3 mm to 8 mm. Thus, by changing the center distance between the toroidal enveloping worm 2 and the helical gear shaft 3, the toroidal enveloping worm and helical gear transmission mechanism for the robot finger joint 100 can be adapted to robot fingers of different sizes.

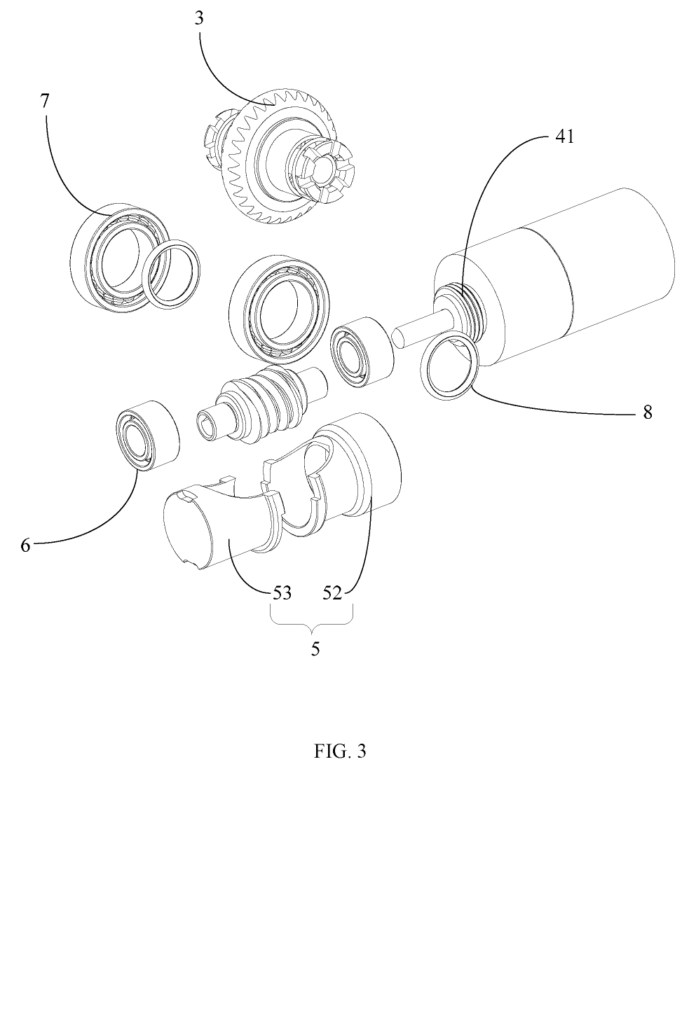

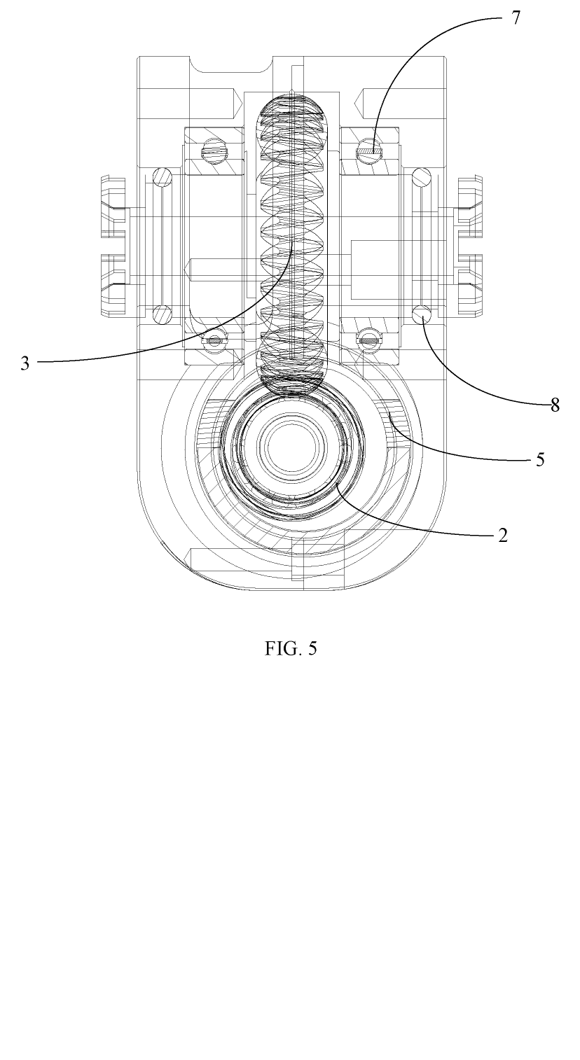

In an embodiment of the present application, referring to FIG. 2, FIG. 3, and FIG. 5, the toroidal enveloping worm and helical gear transmission mechanism for the robot finger joint 100 further includes an eccentric sleeve 5. The eccentric sleeve 5 is rotatably provided in the first accommodating cavity. The middle portion of the eccentric sleeve 5 is provided with a through hole, and two ends of the eccentric sleeve 5 are provided with an eccentric hole. The toroidal enveloping worm 2 is provided in the eccentric sleeve 5, and two ends of the eccentric sleeve 5 are rotatably provided in an eccentric hole. A portion of the helical gear shaft 3 passes through the through hole and meshes with the toroidal enveloping worm 2. It can be understood that the eccentric hole is a hole whose center is not the same as the axis of the eccentric sleeve 5. By rotatably providing the two ends of the toroidal enveloping worm 2 in an eccentric hole, when the eccentric sleeve 5 is rotated, the toroidal enveloping worm 2 will rotate around the axis of the eccentric sleeve 5 under the constraint of the eccentric hole. This changes the distance between the axis of the toroidal enveloping worm 2 and the axis of the helical gear shaft 3, thus making it suitable for robot fingers of different sizes. In order to facilitate the installation and rotation of the eccentric sleeve 5, the housing 1 is provided with two oppositely arranged circular holes that communicate with the first accommodating cavity. The eccentric sleeve 5 includes a first sleeve body 52 and a second sleeve body 53, and the first sleeve body 52 and the second sleeve body 53 are spliced together to form the eccentric sleeve 5. The first sleeve body 52 and the second sleeve body 53 are exposed in the housing 1 through the two circular holes, respectively. The output shaft of the drive motor 4 passes through the first sleeve body 52 and is connected to the toroidal enveloping worm 2. Two accommodating grooves 54 are provided at opposite sides of the end of the second sleeve body 53 exposed outside the housing 1. Thus, by inserting tools into the two accommodating grooves 54 respectively, the second sleeve body 53 is clamped and rotated, thereby driving the toroidal enveloping worm 2 inside the eccentric sleeve 5 to rotate, thus changing the distance between the axis of the toroidal enveloping worm 2 and the axis of the helical gear shaft 3. In addition, in order to allow the output shaft of the drive motor 4 to pass through, the first sleeve body 52 is provided with a through hole communicating the inner cavity of the first sleeve body 52 with the outside. At the same time, the inner wall of the through hole of the first sleeve body 52 is provided with an internal thread, and the corresponding external thread part 41 is provided at the drive motor 4. The external thread portion 41 is screwed to the first sleeve body 52. In this way, the drive motor 4 can be stably connected to the first sleeve body 52 and can rotate together with the first sleeve body 52.

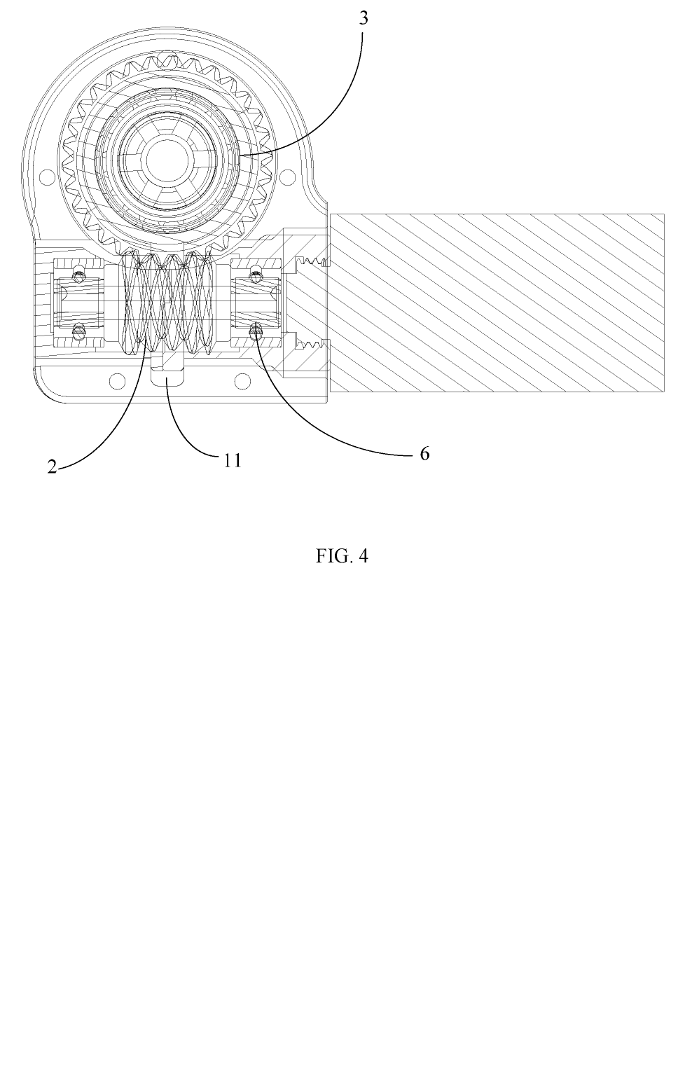

In an embodiment of the present application, referring to FIG. 2 and FIG. 4, an annular groove 11 is formed on the inner wall of the first accommodating cavity, an annular protrusion 51 is formed on the outer wall of the eccentric sleeve 5, and the annular protrusion 51 engages with the annular groove 11. The cooperation between the annular protrusion 51 and the annular groove 11 can provide a mechanical lock, thereby limiting the position of the eccentric sleeve 5 relative to the housing 1. In this way, during the rotation of the eccentric sleeve 5, it can be ensured that the eccentric sleeve 5 will not move relative to the housing 1, and during the rotation of the toroidal enveloping worm 2 driven by the drive motor 4, the eccentric sleeve 5 will not shift.

In an embodiment of the present application, the module of the toroidal enveloping worm 2 and the module of the helical gear shaft 3 are both m, where 0.15 ≤ m ≤ 0.5. Within this range, the accuracy and stability of the toroidal enveloping worm and helical gear transmission mechanism for the robot finger joint 100 can be guaranteed.

In order to improve service life, in an embodiment of the present application, referring to FIG. 3, FIG. 4, and FIG. 5, the toroidal enveloping worm and helical gear transmission mechanism for the robot finger joint 100 further includes two first bearings 6, and the two first bearings 6 are provided in a first accommodating cavity and respectively sleeved on both ends of the toroidal enveloping worm 2. Similarly, the toroidal enveloping worm and helical gear transmission mechanism for the robot finger joint 100 also includes two second bearings 7, and the two second bearings 7 are provided in a second accommodating cavity and respectively sleeved on both ends of the helical gear shaft 3. The arrangement of the first bearings 6 and the second bearings 7 can reduce the direct contact between the toroidal enveloping worm 2 and the inner wall of the housing 1, and between the helical gear shaft 3 and the inner wall of the housing 1, thereby reducing friction and wear, improving rotational efficiency, and also helping to extend service life. The first bearings 6 and the second bearings 7 can also provide stable support points, helping to maintain the position of the toroidal enveloping worm 2 and the transmission rod, ensuring stability. When an eccentric sleeve 5 is provided, the first bearing 6 is correspondingly provided in the eccentric sleeve 5.

In an embodiment of the present application, referring to FIG. 3 and FIG. 5, the toroidal enveloping worm and helical gear transmission mechanism for the robot finger joint 100 further includes two sealing rings 8. The two sealing rings 8 are respectively sleeved on both ends of the helical gear shaft 3, and each sealing ring 8 is hermetically attached to the wall of a through hole. The sealing rings 8 are sleeved on both ends of the helical gear shaft 3, and each sealing ring 8 is hermetically attached to the wall of a through hole, which can effectively prevent dust, moisture or other contaminants from entering the first accommodating cavity, protecting the components from wear or corrosion. In addition, lubricating oil is usually provided in the first accommodating cavity and the second accommodating cavity. The lubricating oil can provide lubrication for the toroidal enveloping worm 2, the helical gear shaft 3, the first bearing 6 and the second bearing 7. In this case, the provision of sealing rings 8 can also prevent lubricating oil from leaking from the inside, ensuring that the components are continuously lubricated, which helps to extend the service life of the components.

The present application also proposes a robot, and the robot includes the above toroidal enveloping worm and helical gear transmission mechanism for the robot finger joint 100. The specific structure of the toroidal enveloping worm and helical gear transmission mechanism for the robot finger joint 100 is according to the above embodiments. Since the robot adopts all the technical solutions of all the above embodiments, it has at least all the beneficial effects brought about by the technical solutions of the above embodiments, which will not be described in detail here.

The above description are some embodiments of the present application and does not limit the scope of the present application. Any equivalent structural modifications made using the contents of the specification and drawings of the present application under the technical concept of the present application, or any direct or indirect application in other related technical fields, are included within the scope of the present application.

What is claimed is:

1. A toroidal enveloping worm and helical gear transmission mechanism for a robot finger joint, comprising:
a housing provided with a first accommodating cavity and a second accommodating cavity communicated with the first accommodating cavity, wherein each of the opposite side walls of the second accommodating cavity is provided with a through hole;
a toroidal enveloping worm provided in the first accommodating cavity;
a helical gear shaft provided in the second accommodating cavity, wherein the helical gear shaft meshes with the toroidal enveloping worm, and both ends of the helical gear shaft respectively pass through the two through holes; and
a drive motor, wherein an output shaft of the drive motor is connected to the toroidal enveloping worm, and the drive motor drives the toroidal enveloping worm to rotate;
wherein an axis of the toroidal enveloping worm is perpendicular to an axis of the helical gear shaft.

2. The toroidal enveloping worm and helical gear transmission mechanism for the robot finger joint according to claim 1, wherein:
the toroidal enveloping worm comprises a rod body and a plurality of teeth provided at the rod body, the plurality of teeth form a transmission section; and
the helical gear shaft meshes with the transmission section, and an outer diameter of the teeth gradually increases from a middle portion of the transmission section to both ends of the transmission section.

3. The toroidal enveloping worm and helical gear transmission mechanism for the robot finger joint according to claim 1, wherein a transmission ratio of the toroidal enveloping worm and helical gear transmission mechanism for the robot finger joint is 10:1 to 30:1.

4. The toroidal enveloping worm and helical gear transmission mechanism for the robot finger joint according to claim 1, further comprising:
an eccentric sleeve;
wherein the eccentric sleeve is rotatably provided in the first accommodating cavity, a middle portion of the eccentric sleeve is provided with a through hole, and eccentric holes are provided at both ends of the eccentric sleeve; and
the toroidal enveloping worm is provided in the eccentric sleeve, two ends of the toroidal enveloping worm are respectively rotatably provided in each of the eccentric holes, and a portion of the helical gear shaft passes through the through hole and meshes with the toroidal enveloping worm.

5. The toroidal enveloping worm and helical gear transmission mechanism for the robot finger joint according to claim 4, wherein:
an annular groove is formed on an inner wall of the first accommodating cavity; and
an annular protrusion is formed on an outer wall of the eccentric sleeve, and the annular protrusion is engaged with the annular groove.

6. The toroidal enveloping worm and helical gear transmission mechanism for the robot finger joint according to claim 1, wherein a distance between an axis of the toroidal enveloping worm and an axis of the helical gear shaft is 3 mm to 8 mm.

7. The toroidal enveloping worm and helical gear transmission mechanism for the robot finger joint according to claim 1, wherein a module of the toroidal enveloping worm and a module of the helical gear shaft are both m, wherein 0.15 ≤ m ≤ 0.5.

8. The toroidal enveloping worm and helical gear transmission mechanism for the robot finger joint according to claim 1, further comprising:
two first bearings,
wherein the two first bearings are provided in the first accommodating cavity, and the two first bearings are respectively sleeved on both ends of the toroidal enveloping worm.

9. The toroidal enveloping worm and helical gear transmission mechanism for the robot finger joint according to claim 8, further comprising:
two second bearings,
wherein the two second bearings are provided in the second accommodating cavity, and the two second bearings are respectively sleeved on both ends of the helical gear shaft.

10. The toroidal enveloping worm and helical gear transmission mechanism for the robot finger joint according to claim 1, further comprising:
two sealing rings,
wherein the two sealing rings are respectively sleeved on both ends of the helical gear shaft, and each of the sealing rings is hermetically attached to a hole wall of one of the through holes.

11. A robot, comprising the toroidal enveloping worm and helical gear transmission mechanism for the robot finger joint according to claim 1.
